(19) United States
(12) Patent Application Publication
(10) Pub. No.: US 2006/0292531 A1
(43) Pub. Date: Dec. 28, 2006

(54) Method for developing cognitive skills

(76) Inventor: Kenneth H. Gibson, Colorado Springs, CO (US)

Correspondence Address: BARBER LEGAL, P.O. BOX 16220, GOLDEN, CO, 80402-6004, US

(21) Appl. No.: 11/158,508

(22) Filed: Jun. 22, 2005

(51) Int. Cl. G09B 19/00

(52) U.S. Cl. 434/236; 434/362

(57) ABSTRACT

The present invention teaches that cognitive skills may be trained by methods of increasing loading, distraction and pace while a trainee is carrying out a cognitive skill related repetitive mental task. Loading may comprise addition of a second repetitive mental task, distraction may be visual, auditory, kinesthetic and may increase in the power of the distraction, and pace may be increased until a maximum pace is achieved. Patterned, continuous, intermittent, and combined loading, distraction and pace changes may be used, as well as patterned feedback. The result is that the student learns to process the stimuli—using the cognitive skills—at increased levels of efficiency and speed.

### FIELD OF THE INVENTION

This invention relates generally to education and specifically to methods of training of cognitive skills and overall cognitive skill categories.

### CROSS-REFERENCE TO RELATED APPLICATIONS

N/A

### STATEMENT REGARDING FEDERALLY FUNDED RESEARCH

This invention was not made under contract with an agency of the US Government, nor by any agency of the US Government.

### BACKGROUND OF THE INVENTION

Cognitive skills are a class of skills dealing with cognition. Cognition, according to the Oxford University Press is “the mental acquisition of knowledge through thought, experience and the senses”. Thus, cognition deals with basic processes of thought and learning. Cognition is not knowledge, but knowledge is often the goal cognitive skills. The seven definite cognitive skills are short term memory, long term memory, visual processing, auditory processing, logic and reasoning, attention, and processing speed. These are broad categories including within each a number of sub-categories/sub-skills. Cognitive skills may be thought of as the “tools” for learning and processing information. As an example, auditory skills are obviously required for language acquisition, logic and reasoning ability for learning of mathematics and so on.

In general, individuals (especially children, but trainees of all ages) with poor cognitive skills (i.e. poor learning skills) suffer an automatic disadvantage in the educational process: acquisition of a given measure or unit additional knowledge content is made more difficult for those with poor cognitive skills than acquisition of the same measure of knowledge is for another student of the same material. A student with poor “processing speed” skills will simply require longer for a given task, while a student with poor visual processing skills with require longer in any task which depends upon the ability to visualize something, and so on. Over time, this small gap in a first unit of knowledge is compounded as the student functionally falls further and further behind.

However, such students are not necessarily “stupid” or “mentally challenged”. On the contrary, many students with one or two poor cognitive skills may have other strong cognitive skills. This is the reason that some people are good at certain tasks but poor at others.

Various methods have been proposed for training of cognitive skills. For example U.S. Pat. No. 6,457,975 issued Oct. 1, 2002 to Miranda et al attempts to improve cognitive skills by decomposition of the learning task into components.

U.S. Pat. No. 6,652,283 issued Nov. 25, 2003 to Van Schaack et al teaches a “learning engine” which uses various modules (learning module, scheduling module, etc) to teach a pupil.

However, it is not known to aid cognitive skills development by means of increasing the mental demands on the pupil in order to make simple cognitive skills increasingly less conscious and increasingly easy, at a rate the student is able to handle.

### SUMMARY OF THE INVENTION

General Summary

The present invention teaches that cognitive skills may be trained by methods of increasing loading, distraction and pace while a trainee is carrying out a cognitive skill related repetitive mental task. Loading may comprise addition of a second repetitive mental task, distraction may be visual, auditory, kinesthetic and may increase in the power of the distraction, and pace may be increased until a maximum pace is achieved. Patterned, continuous, intermittent, and combined loading, distraction and pace changes may be used, as well as patterned feedback. The result is that the student learns to process the stimuli—using the cognitive skills—at increased levels of efficiency and speed.

The human brain is capable of increasing its ability to use cognitive skills, that is, of learning the skills necessary for further learning. By presenting simple and repetitive tasks and then increasing the mental loading of doing those tasks, the method of the invention trains the basal cognitive skills used.

Summary in Reference to Claims

It is therefore a first aspect, advantage, objective and embodiment of the invention to provide a method of training cognitive skills comprising the steps of:

(a) presenting repetitive primary task targeting a cognitive skill to train to a trainee for a duration of time, the repetitive task requiring repeated responses;

(b) adding a conscious stimuli to a repetitive primary task so that the cognitive skill being trained is enhanced;

(c) monitoring the trainee's performance in each of steps (a) and (b) to determine the degree the cognitive skill has improved and become automatic;

(d) modifying the repetitive primary task of at least one of steps (a) and (b) based on the results of steps (c).

It is therefore another aspect, advantage, objective and embodiment of the invention to provide a method of training cognitive skills wherein the step (b) of adding a conscious stimuli consists of one member selected from the group consisting of:

(a) adding a pace to a repetitive primary task to increase the speed of processing;

(b) adding a distraction to a repetitive primary task;

(c) adding a mental activity to a repetitive primary task; and

(d) combinations thereof.

It is therefore another aspect, advantage, objective and embodiment of the invention to provide a method of training cognitive skills wherein the addition of a mental activity further comprises:

adding a second repetitive task.

It is therefore another aspect, advantage, objective and embodiment of the invention to provide a method of training cognitive skills wherein the step (b) of adding a conscious stimuli to a repetitive primary task further comprises an additional complexity of presentation selected from the group consisting of: intermittent presentation, separate presentation of one conscious stimuli, combination presentation of a plurality of conscious stimuli, and combinations thereof.

It is therefore another aspect, advantage, objective and embodiment of the invention to provide a method of training cognitive skills further comprising:

e) increasing the length of the duration of the repetitive primary task.

It is therefore yet another aspect, advantage, objective and embodiment of the invention to provide a method of training cognitive skills wherein adding a pace further comprises:

increasing the task pace with task achievement up to a maximum task pace.

It is therefore yet another aspect, advantage, objective and embodiment of the invention to provide a method of training cognitive skills wherein adding a distraction further comprises one member selected from the group consisting of: increasing distraction sensory intensity from quiet to loud, increasing distraction significance from meaningless to meaningful, increasing the distraction from random to consistent and combinations thereof.

It is therefore yet another aspect, advantage, objective and embodiment of the invention to provide a method of training cognitive skills wherein the added mental activity increases over time from requiring minimal consciousness to demanding substantial cognitive attention.

It is therefore yet another aspect, advantage, objective and embodiment of the invention to provide a method of training cognitive skills wherein the added mental task comprises a cognitive task requiring more consciousness than the primary task requires.

It is therefore yet another aspect, advantage, objective and embodiment of the invention to provide a method of training cognitive skills wherein the added mental task comprises a cognitive task requiring almost total consciousness.

It is therefore yet another aspect, advantage, objective and embodiment of the invention to provide a method of training cognitive skills further comprising:

f) providing feedback to the trainee when responses fail to be accurate and timely.

It is therefore yet another aspect, advantage, objective and embodiment of the invention to provide a method of training cognitive skills wherein the step of providing student feedback further comprises:

one member selected from the group consisting of: providing immediate correction, providing delayed correction thereby giving the student a chance to self correct, providing correction after the task is completed and combinations thereof.

It is therefore yet another aspect, advantage, objective and embodiment of the invention to provide a method of training cognitive skills further comprising the step of providing feedback to the student after a plurality of responses fail to be made as required, the feedback provided by means of one member selected from the group consisting of visual stimuli, auditory stimuli, kinesthetic stimuli, and combinations thereof.

It is therefore yet another aspect, advantage, objective and embodiment of the invention to provide a method of training cognitive skills further comprising the step of:

g) reporting numerical performance feedback to the student at the end of task interval,

h) comparing numerical performance to a pre-assigned passing performance level, and wherein

i) a passing performance results in advancement to an increased level of difficulty while a non-passing performance level of performance results in repetition of the primary task.

It is therefore yet another aspect, advantage, objective and embodiment of the invention to provide a method of training cognitive skills further comprising:

j) providing a repetitive and patterned time interval to indicate to the trainee the required pace of responses.

It is therefore yet another aspect, advantage, objective and embodiment of the invention to provide a method of training cognitive skills wherein the required pace is provided by means of one member selected from the group consisting of visual stimuli, auditory stimuli, kinesthetic stimuli, and combinations thereof.

It is therefore yet another aspect, advantage, objective and embodiment of the invention to provide a method of training cognitive skills wherein the cognitive skills to be trained by the trainee includes at least one member selected from the group consisting of: attention, processing speed, short term memory, visual processing, auditory processing, long term memory, logic/reasoning, and cognitive sub-skills thereof.

It is therefore yet another aspect, advantage, objective and embodiment of the invention to provide a method of training cognitive skills wherein the trained repetitive primary task and the conscious stimuli are provided by a digital device with a visual display.

It is therefore yet another aspect, advantage, objective and embodiment of the invention to provide a method of training cognitive skills further comprising the step of having the digital device with a visual display monitor timing and accuracy of responses and implement progress based on the speed and accuracy of the responses.

It is therefore yet another aspect, advantage, objective and embodiment of the invention to provide a method of training cognitive skills wherein the digital device with a visual display is programmed to further carry out one member selected from the group consisting of: increase intensity of conscious stimuli based on the speed of the responses, increase complexity of conscious stimuli based on the speed of the responses, increase pace of the repetitive primary task based upon speed of the responses, provide feedback based upon speed of the responses, increase intensity of conscious stimuli based on the accuracy of the responses, increase complexity of conscious stimuli based on the accuracy of the responses, increase pace of the repetitive primary task based upon accuracy of the responses, provide feedback based upon accuracy of the responses, and combinations thereof.

### BRIEF DESCRIPTION OF THE DRAWINGS

FIG. 1 is a block diagram of seven cognitive skills.

FIG. 2 is a pictorial representation of an electronic device programmed to carry out the method of the invention.

FIG. 3 is a flow chart of a preferred embodiment and best mode now contemplated for carrying out the invention.

FIG. 4 is a diagram used in a simple repetitive cognitive skill training mental task.

FIG. 5 is a first example diagram used in a cognitive skill training test.

FIG. 6 is a second example diagram used in a cognitive skill training test.

FIG. 7 is a third example diagram used in a cognitive skill training test.

FIG. 8 is a fourth example diagram used in a cognitive skill training test.

### INDEX TO REFERENCE NUMERALS

Seven cogniskills 100

Processing speed 102

Short-term memory 104

Long-term memory 106

Visual processing 108

Auditory processing 112

Logic and reasoning 114

Attention 116

Repetitive mental task 218

Distraction 220

Controls 222

Electronic device 224

Present repetitive primary task 302

Monitor performance and increases 306

Increasing mental training/tasking 308

Alter nature of mental tasking 310

Increase duration of primary task 312

Increase distraction power 314

Increase loading of secondary task 316

Provide feedback 318

Arrow having direction 420

### DETAILED DESCRIPTION

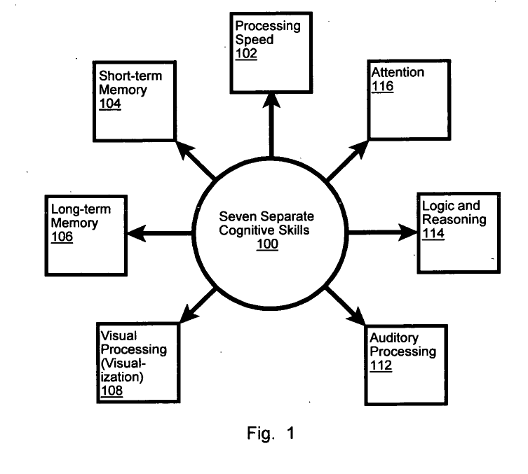

FIG. 1 is a block diagram of seven cognitive skills. These seven cognitive skills 100 work together but are separate and independent of each other. For example, solving an equation may require reasoning, long term memory, processing speed, and attention, but each one separately are not dependent on the other, however, solving the equation is dependent on all of them. If one on these skills is significantly weak, it will affect either the accuracy, time, or effort required to complete the task. Each of these skill areas actually represents a number of sub-skills, those sub-skills of a given congiskill are related based upon factor analysis, but whose exact inter-relationships indicate the complexity of human cognition. Because each of these sub-skills are to a small degree correlated to each other but yet separate enough to be distinct, training one sub-skill under a major skill will benefit the other sub-skills under the same major skill but to a lesser degree than the skill being trained. Table 1 indicates some of the sub-skills of given cognitive skills.

TABLE ONE
Logic and Reasoning: The use of deliberate and controlled mental
operations to solve novel on the spot problems (i.e., tasks that
cannot be performed automatically). Sub-skills include:

Deductive Reasoning: Ability to start with stated assertions
(rules, premises, or conditions) and to engage in one or more
steps leading to a solution to a problem.
Induction Reasoning: Ability to discover the underlying
characteristic (e.g., rule, concept, principle, process, trend,
class membership) that underlies a specific problem or a set of
observations, or to apply a previously learned rule to the problem.
Quantitative Reasoning: Ability to inductively (I) and/or
deductively (RG) reason with concepts involving mathematical
relations and properties.
Piagetian Reasoning: Ability to a) organizing material into an
orderly series that facilitates understanding of relationships
between events, b) be aware that physical quantitaties do not
change in amount when altered in appearance), c) organize
materials that possess similar characteristics into
categories, etc.
Speed of Reasoning: Speed or fluency in performing reasoning
tasks (e.g., quickness in generating as many possible rules,
solutions, etc., to a problem) in a limited time.

Visual Processing: The ability to generate, retain, retrieve, and
transform well-structured visual images. Sub-skills include:

Visualization: The ability to apprehend a spatial form, object,
or scene and match it with another spatial object, form, or
scene with the requirement to rotate it (one or more times)
in two or three dimensions.
Spatial Relations: Ability to rapidly perceive and manipulate
(mental rotation, transformations, reflection, etc.) visual
patterns or to maintain orientation with respect to
objects in space.
Closure Speed: Ability to quickly identify a familiar
meaningful visual object from incomplete (vague, partially
obscured, disconnected) visual stimuli, without knowing in
advance what the object is.
Flexibility of Closure: Ability to identify a visual figure
or pattern embedded in a complex distracting or disguised
visual pattern or array, when knowing in advance what
the pattern is.
Visual Memory: Ability to form and store a mental
representation or image of a visual shape or configuration
(typically during a brief study period), over at least a few
seconds, and then recognize or recall it later (during the
test phase).
Spatial Scanning: Ability to quickly and accurately survey
(visually explore) a wide or complicated spatial field or
pattern and identify a particular configuration (path) through
the visual field.
Serial Perceptual Integration: Ability to identify (and
typically name) a pictorial or visual pattern when parts
of the pattern are presented rapidly in serial order
(e.g., portions of a line drawing of a dog are passed in
sequence through a small window).
Length Estimation: Ability to accurately estimate or compare
visual lengths or distances without the aid of measurement
instruments.
Perceptual Illusions: The ability to resist being affected
by the illusory perceptual aspects of geometric figures
(i.e., not forming a mistaken perception in response to some
characteristic of the stimuli).
Perceptual Alternations: Consistency in the rate of
alternating between different visual perceptions.
Imagery: Ability to mentally depict (encode) and/or manipulate
an object, idea, event or impression (that is not present)
in the form of an abstract spatial form.

Auditory Processing: Abilities that depend on sound as input and on
the functioning of our hearing apparatus. The extent an individual
can cognitively handle the competition between signal and noise.
The perception of auditory information. Sub-skills include:

Phonetic Coding: Ability to code, process, and be sensitive
to nuances in phonemic information (speech sounds) in
short-term memory.
Speech Sound Discrimination: Ability to detect and
discriminate differences in phonemes or speech sounds under
conditions of little or no distraction or distortion.
Resistance to Auditory Stimulus Distortion: Ability to
overcome the effects of distortion or distraction when
listening to and understanding speech and language.
Memory for Sound Patterns: Ability to retain (on a short-term
basis) auditory events such as tones, tonal patterns, and voices.
General Sound Discrimination: Ability to discriminate tones,
tone patterns, or musical materials with regard to their
fundamental attributes (pitch, intensity, duration, and rhythm).
Temporal Tracking: Ability to mentally track auditory temporal
(sequential) events so as to be able to count, anticipate or
rearrange them (e.g., reorder a set of musical tones).
Musical Discrimination: Ability to discriminate and judge
tonal patterns in music with respect to melodic, harmonic,
and expressive aspects (e.g., phrasing, tempo, harmonic
complexity, intensity variations).
Maintaining Rhythm: Ability to recognize and maintain a
musical beat.
Sound-Intensity/Duration Discrimination: Ability to
discriminate sound intensities and to be sensitive to the
temporal/rhythmic aspects of tonal patterns.
Sound-Frequency Discrimination: Ability to discriminate
frequency attributes (pitch and timbre) of tones.
Hearing Threshold: Ability to hear pitch and varying sound
frequencies.
Absolute Pitch: Ability to perfectly identify the pitch of tones.
Sound Localization: Ability to localize heard sounds in space.

Long-term Memory: The ability to store and consolidate new
information in long-term memory and later fluently retrieve the
stored information (e.g., concepts, ideas, items, names) through
association. Sub-skills include:

Associative Memory: Ability to recall one part of a previously
learned but unrelated pair of items (that may or may not be
meaningfully linked) when the other part is presented
(e.g., paired-associative learning).
Meaningful Memory: Ability to note, retain, and recall
information (set of items or ideas) where there is a meaningful
relation between the bits of information, the information
comprises a meaningful story or connected discourse, or the
information relates to existing contents of memory.
Free Recall Memory: Ability to recall (without associations)
as many unrelated items as possible, in any order, after a
large collection of items is presented (each item presented
singly).
Ideational Fluency: Ability to rapidly produce a series of
ideas, words, or phrases related to a specific condition or object.
Associational Fluency: A highly specific ability to rapidly
produce a series of words or phrases associated in meaning
(semantically associated; or some other common semantic
property) when given a word or concept with a restricted
area of meaning.
Expressional Fluency: Ability to rapidly think of and
organize words or phrases into meaningful complex ideas
under general or more specific cued conditions.
Naming Facility: Ability to rapidly produce accepted names
for concepts or things when presented with the thing itself
or a picture of it (or cued in some other appropriate way).
Word Fluency: Ability to rapidly produce isolated words that
have specific phonemic, structural, or orthographic
characteristics (independent of word meanings).
Figural Fluency: Ability to rapidly draw or sketch as many
things (or elaborations) as possible when presented with a
non-meaningful visual stimulus (e.g., set of unique visual
elements).
Figural Flexibility: Ability to rapidly change set and try-out
a variety of approaches to solutions for figural problems that
have several stated criteria.
Sensitivity to Problems: Ability to rapidly think of a number
of alternative solutions to practical problems (e.g., different
uses of a given tool).
Originality/Creativity: Ability to rapidly produce unusual,
original, clever, divergent, or uncommon responses (expressions,
interpretations) to a given topic, situation, or task.

Short-term Memory: The ability to apprehend and maintain awareness
of elements of information in the immediate situation (events that
occurred in the last minute or so). Sub-skills include:

Memory Span: Ability to attend to, register, and immediately
recall (after only one presentation) temporally ordered
elements and then reproduce the series of elements in
correct order.
Working Memory: Ability to temporarily store and perform a
set of cognitive operations on information that requires
divided attention and the management of the limited capacity
resources of short-term memory.

Processing Speed: The ability to automatically and fluently perform
relatively easy or over-learned cognitive tasks, especially when
high mental efficiency (i.e., attention and focused
concentration) is required. Sub-skills include:

Perceptual Speed: Ability to rapidly and accurately search,
compare (for visual similarities or differences) and identify
visual elements presented side-by-side or separated in a
visual field.
Rate-of-Test-Taking: Ability to rapidly perform tests which
are relatively easy or overlearned (require very simple
decisions).
Number Facility: Ability to rapidly perform basic arithmetic
(i.e., add, subtract, multiply, divide) and accurately
manipulate numbers quickly.
Speed of Reasoning: Speed or fluency in performing reasoning
tasks (e.g., quickness in generating as many possible rules,
solutions, etc., to a problem) in a limited time.
Reading Fluency: Ability to silently read and comprehend
connected text (e.g., a series of short sentences; a passage)
rapidly and automatically (with little conscious attention to
the mechanics of reading).
Writing Fluency: Ability to copy correctly words or sentences
repeatedly, or writing words, sentences, or paragraphs, as
quickly as possible.
Decision/Reaction Speed: The ability to react and/or make
decisions quickly in response to simple stimuli, typically
measured by chronometric measures of reaction and
inspection time.
Psychomotor Speed: The ability to rapidly and fluently
perform body motor movements (movement of fingers, hands,
legs, etc.) independent of cognitive control.

Attention: Ability to focus on a task. Sub-skills include:

Sustain Attention: Ability to maintain concentrate on a task
for a period of time.
Selected Attention: Ability to maintain concentrate of a task
in the presence of distractions.
Divided Attention: Ability to split concentration between two
or more task.

As noted, there are inter-relationships between these sub-skills. For example, processing speed 102 is related to (or may be said to include) perceptual speed, number facility and others. Visual processing 108 as a skill group may include and/or relate to visual memory, length estimation and so on.

It may be seen that these skills are inter-related, may be categorized in various different ways, and that the examples listed are exemplary only: there are other skills than those listed which fall within the eight general cogniskills discussed. Regardless of exact definitions or details of classification of the skills; all such cognitive skills, “learning tools” are considered to fall within the ambit of the present application.

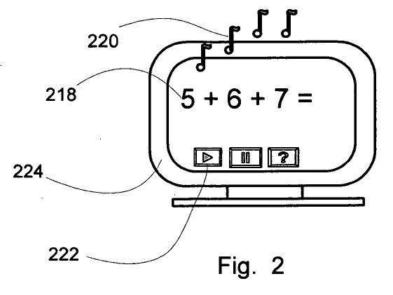

In the preferred embodiments of the invention, cogniskill training is carried out on a one to one basis between a trainer and a trainee, using fairly simple devices such as charts, diagrams, stop watches, and metronomes. However, such training may be somewhat carried out using a digital device. FIG. 2 is a pictorial representation of an electronic device 224 programmed to carry out the method of the invention. Repetitive mental task 218 is presented to the student electronically. Distraction 220, an additional repetitive mental task, a pace or some other increase in mental tasking is also presented.

Electronic device 224 would usually be considered to be a computer, however, it need not be so limited. For example, electronic device 224 may be some other device incorporating a programmable CPU. Electronic device may also be a device lacking reprogrammability, that is, one lacking true central processing capability, or one with all activities controlled by non-CPU electronic means (a hard-wired device lacking programmability in any way), a child's game device and so on. Electronic device 224 may also be a device having a primary function distinct from learning, such as a calculator, cellular telephone, game or the like. (As with all examples in this disclosure, the method of the invention is not limited to this particular device. Any device may be used in embodiments of the invention and fall within the scope of the appended claims.) In general, electronic device 224 may be any a digital device with a visual display to present stimuli and repetitive tasks, distractions, feed back and the like.

Controls 222 further allow the device to monitor timing and accuracy of responses and implement progress based on the speed and accuracy of the responses. The electronic device 224 may even increase intensity of conscious stimuli based on the speed of the responses, increase complexity of conscious stimuli based on the speed of the responses, increase pace of the repetitive primary task based upon speed of the responses, provide feedback based upon speed of the responses, increase intensity of conscious stimuli based on the accuracy of the responses, increase complexity of conscious stimuli based on the accuracy of the responses, increase pace of the repetitive primary task based upon accuracy of the responses, provide feedback based upon accuracy of the responses, and combinations thereof.

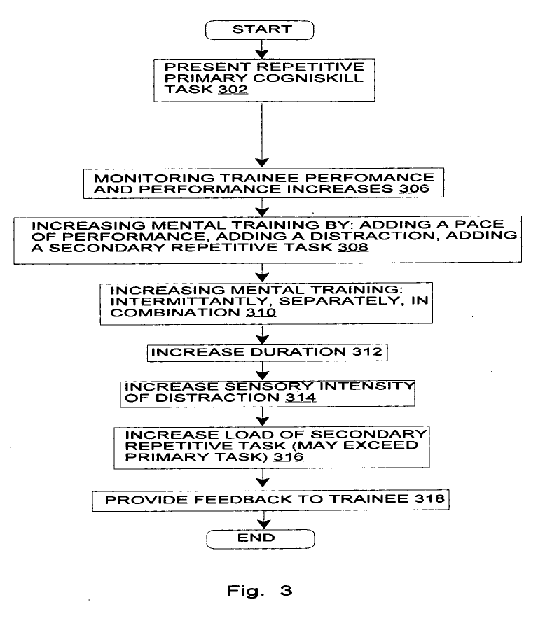

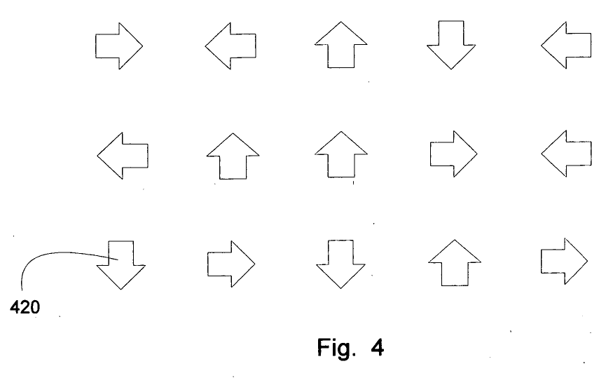

FIG. 3 is a block diagram of a preferred embodiment and best mode now contemplated for carrying out the invention. Present repetitive primary task 302 in general consists of requiring the student to repeatedly consciously carry out a simple task such as identifying the direction an arrow points, identifying the color of a word, answering questions about auditory or visual input and the like. This task is one requiring conscious effort on the part of the trainee. For example, the trainer may present a simple question or a simple chart, then ask questions about the information presented. The task is made repetitive by the process of asking repeated questions. FIG. 4 is a diagram used in a simple repetitive cognitive skill training mental task showing this method. The trainer points to arrow 420 and asks the student which way it points, then the student is asked to identify the direction of another arrow, and another, and so on. Such simple tasks may be presented so as to require use of any of the skills or sub-skills of the cognitive chart of FIG. 1. For example, the student may be asked, “Which direction would arrow 420 point if rotated 90 degrees clockwise?” This question requires the student to visualize “clockwise” and “90 degrees” and then apply that rotation to the arrow to successfully visualize the arrow pointing in another direction. Thus for a duration of time, the repetitive task requires repeated responses. Note that the stimuli should be conscious, not un-conscious, sub-conscious or pre-consciously filterable. The objective is to increase the mental burden on the trainee, to force the trainee to use less of their mind for handling the original primary repetitive task. Obviously, this is only implemented based upon monitoring of the student's original ability to carry out the primary task unburdened with other mental activity.

Monitor performance and increases 306 thus tracks the student's ability to complete the task in terms of speed or accuracy. The increases in speed and accuracy are of particular interest, and these increases in ability lead to the increasing of mental training/tasking 308 in which additional mental activity is required of the student.

Altering the nature of the mental tasking, step 310, may take several forms: the original task may become harder or a secondary mental task (a second repetitive mental task) may be added. A “pace” or time factor may be added to the repetitive task: each response must be made in ten seconds, then in six seconds, five seconds, three seconds and so on. Addition of such a pace increases the student's proficiency at the task and also serves to demonstrate to the student that learning efficiency is truly increasing. The pace may be provided in a repetitive or patterned way so as to indicate to the student the proper time for response. As an example, the response may be made to the beat of a metronome or other electronic or mechanical device which provides a beat. However, the pace may be caused to vary in a pattern: a three second response window for a first stimuli, then a six second response window to a second stimuli, followed by a five second response window to a third stimuli and then a repetition of the pattern of the pace. (As with all examples herein, the method of the invention is not limited to this particular pace pattern. Any pattern may be used in embodiments of the invention and fall within the scope of the appended claims.)

Yet another method is to alter the nature of the presentation of the repetitive primary mental task: providing intermittent presentation, separate presentation of one conscious stimuli, combination presentation of a plurality of conscious stimuli, and combinations thereof. As an example, the conscious stimuli of a verbal statement may be provided in different voices, may be offered only intermittently while other (visual) stimuli are offered consistently, and so on.

A different method is to increase the first duration of the primary task 312 to a longer second duration. For example, a 3 minute run may be increased to a 10 minute run when the student demonstrates competence in terms of a “pass level” of speed and/or accuracy of response. Or, a single run through the chart of FIG. 4 may be replaced by three runs through the chart, going backwards. Other methods of increasing the nature of the mental tasking may be used. An increase in distraction power 314 is another method. This increase may occur in several ways: increasing distraction sensory intensity from quiet to loud, increasing distraction significance from meaningless to meaningful, increasing the distraction from random to consistent and combinations thereof. For example, the distraction may be an auditory and random noise such as the instructor/trainer occasionally clapping their hands. However, the distraction sensory intensity may be increased. The claps can become louder and more frequent. The claps may begin to assume a meaningful pattern or rhythm such as the rhythm of a common tune. Kinesthetic distractions (touching the student in a distracting but non-threatening manner, for example) or visual distractions (motions, colors, appearance of objects and text and so on) may be used as well.

Increasing the loading of the secondary task (see step 316) may include increasing the conscious loading of the secondary task until it actually requires more attention than the primary repetitive mental task, or even increasing the loading of the secondary task until it actually requires near total concentration. Yet the original task remains in place, and student proficiency necessarily increases as they demonstrate increased ability to handle the conscious task with less and less processing and attention.

Providing feedback 318 to the trainee when responses fail to be accurate and timely aids learning considerably. The feedback may take several forms: providing immediate correction, providing delayed correction thereby giving the student a chance to self correct, providing correction after the task is completed and combinations thereof as well as choices of providing visual stimuli, auditory stimuli, kinesthetic stimuli, and combinations thereof. Feedback may be provided in a numerical form such as a score or time, and the numerical performance may be reported the student at the end of task interval, or by comparing numerical performance to a pre-assigned passing performance level, and/or by providing that a passing performance results in advancement to an increased level of difficulty while a non-passing performance level of performance results in repetition of the primary task. As an example, kinesthetic feedback may be provided by tapping the pupil's hand with a pen when an incorrect response is made, or visually with a representation of the incorrect response and the stimuli that it responded to, or verbally, etc.

One type of skill building routine is the “COLOR ARROWS” chart, in which a student identifies direction of arrows, or in the color version, identifies color of the arrows as well. A series of arrows are presented to the student (preferably at a pace) while the student provides the desired information.

Table two and FIG. 4 may be consulted at the same time in understanding this.

TABLE TWO
Color Arrows

| | |
|---|---|
| Main skills developed: | Divided Attention, Processing Speed, Selective Attention, Sustained Attention, |
| | Visual Manipulation, Visualization, Working Memory |
| Equipment: | Color arrow chart (separate sheet) and metronome |
| Procedure: | The student should read the directions or colors of the arrows. Passing |
| | a level is all correct and in beat |

| Ribbon | | Bronze | | Silver | | Gold | | | |
|---|---|---|---|---|---|---|---|---|---|
| Level | | Level | | Level | | Level | | Level | |
| 30 | sec | 20 | sec | 15 | sec | 10 | sec | 1 | The student should call out the colors of the |
| | | | | | | | | | arrows without error in 3 rows within 30 seconds. |
| 30 | sec | 20 | sec | 15 | sec | 10 | sec | 2 | The student should call out the direction of the |
| | | | | | | | | | arrows without error in 3 rows within 30 seconds. |
| | | | | | | | | | Set metronome as indicated |
| 85 | bpm | 108 | bpm | 120 | bpm | 160 | bpm | 3 | The student should call out the colors of the arrows |
| | | | | | | | | | in 4 rows on every other beat. |
| 85 | bpm | 108 | bpm | 120 | bpm | 160 | bpm | 4 | The student should call out the direction of the |
| | | | | | | | | | arrows in 4 rows on every other beat. |
| 85 | bpm | 108 | bpm | 120 | bpm | 160 | bpm | 5 | The student should call out the direction of the |
| | | | | | | | | | arrows in 4 rows and point his/her hand in the |
| | | | | | | | | | same direction on every other beat (for more of a |
| | | | | | | | | | challenge, try it every beat). |

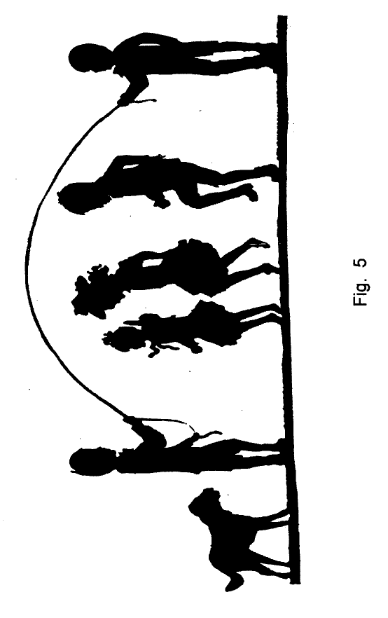

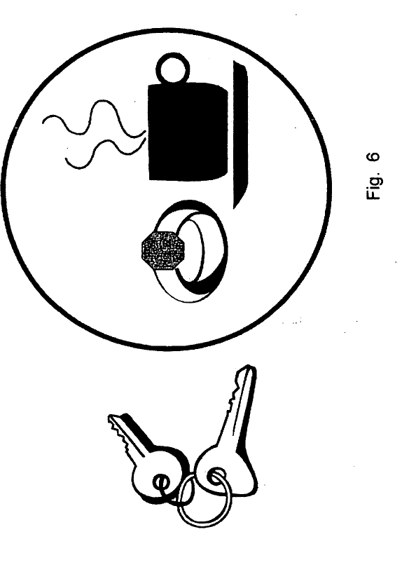

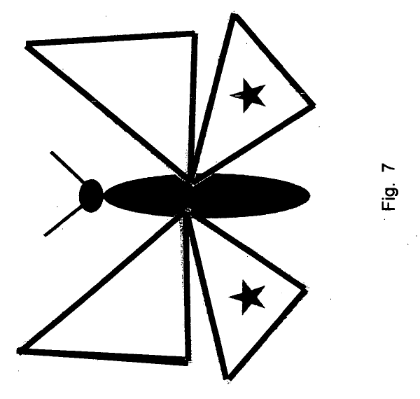

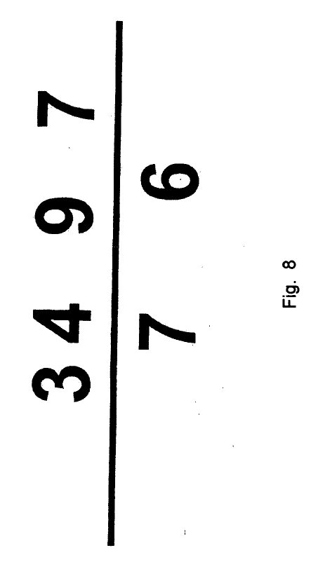

FIG. 5 is a first example diagram used in a cognitive skill training session, FIG. 6 is a second example diagram used in cognitive skill training. FIG. 7 is a third example diagram used in cognitive skill training and FIG. 8 is a fourth example diagram used in cognitive skill training. A single diagram may be used, or in embodiments the diagrams may be presented in order, with questions asked after each presentation.

In preferred embodiments, the presentation of the visual stimuli of pictures may be accompanied by presentation of auditory stimuli such as statements of facts which may or may not relate to the pictures shown.

Table Three provides the first few repetitions of the this process as a working example of the method of loading of the invention, in which the repetitive task continues for a duration and becomes somewhat more complex as more stimuli are added and older stimuli are referenced.

TABLE THREE

| “I WILL BE READING YOU SENTENCES, | |
|---|---|
| SHOWING YOU PICTURES, AND ASKING YOU | |
| QUESTIONS. YOU WILL NEED TO LISTEN AND | |
| LOOK VERY CAREFULLY TO REMEMBER WHAT | |
| YOU HEAR AND SEE. SOMETIMES THE | |
| QUESTIONS WILL BE ABOUT THINGS YOU | |
| HEARD OR SAW EARLIER” | SCORING |
| LISTEN: “HARRY THE CAT SAT ON | |
| GRANDMA'S FRONT PORCH.” | |
| SHOW FIG. 5 (4 sec) | |
| WHERE WAS THE CAT SITTING? | _AM |
| (GRANDMA'S FRONT PORCH) | |
| IN THE PICTURE OF CHILDREN, WHAT ANIMAL | _VM |
| WATCHED THE CHILDREN? (DOG) | |
| LISTEN: “SHAWN, WHO GOES TO ROOSEVELT | |
| HIGH SCHOOL, DRIVES HIS MOTHER'S BLUE | |
| JEEP.” | |
| SHOW FIG. 6 (4 sec) | |
| “WHAT IS THE NAME OF THE CAT?” | _AM |
| (HARRY) | |
| “WHAT SCHOOL DOES SHAWN ATTEND?” | _AM |
| (ROOSEVELT HIGH SCHOOL) | |
| “IN THE PICTURE OF CHILDREN, HOW MANY | _VM |
| CHILDREN WERE NOT JUMPING?” (TWO) | |
| “IN THE CIRCLE PICTURE, WHAT OBJECTS | _VM |
| WERE INSIDE THE CIRCLE?” | |
| (CUP AND RING) | |
| LISTEN: “BILLY'S FATHER TRAINS A | |
| HALF DOZEN HORSES EACH YEAR FOR THE | |
| DENVER RODEO.” | |
| SHOW FIG. 7 (4 sec) | |
| “WHAT COLOR IS THE JEEP THAT | _AM |
| SHAWN DRIVES? | |
| (BLUE) | |
| “HOW MANY HORSES ARE TRAINED | _AM |
| EACH YEAR?” | |
| (HALF A DOZEN, OR 6) | |
| “IN THE CIRCLE PICTURE, WHAT | _VM |
| OBJECTS ARE OUTSIDE OF THE | |
| CIRCLE?” (KEYS) | |
| “IN THE BUTTERFLY PICTURE, HOW MANY | _VM |
| TRIANGLES ARE THERE?” (FOUR) | |
| LISTEN: “EACH SATURDAY MORNING, | |
| BRETT WASHES CARS TO EARN MONEY TO | |
| HELP PAY FOR A BUS TICKET TO HIS | |
| GRANDFATHER'S TURKEY FARM.” | |
| SHOW FIG. 8 (4 sec) | |
| (Test continues with statements, pictures, | |
| and questions requiring visualization of | |
| the pictures, processing of the auditory | |
| information, and scoring of auditory and | |
| visual responses right and wrong.) | |

Auditory skills may be scored (“AM”) and visual skills (“VM”) separately, thus allowing the trainer during the monitoring and feedback phases to determine which particular areas of the cognitive skills universe require the most attention. Of course, numerous other questions, diagrams, test patterns, paces and distraction levels may be used within the claimed method of the invention.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A method of training cognitive skills comprising the steps of:
(a) presenting repetitive primary task targeting a cognitive skill to train to a trainee for a duration of time, the repetitive task have a conscious stimuli and requiring repeated responses;
(b) increasing mental demand in addition to the repetitive primary task so that the cognitive skill being trained is enhanced;
(c) monitoring the trainee's performance in each of steps (a) and (b) to determine the degree the cognitive skill has improved and become automatic;
(d) modifying the repetitive primary task of at least one of steps (a) and (b) based on the results of steps (c).

2. The method of claim 1, wherein the step (b) of increasing mental demand consists of one member selected from the group consisting of:
(a) adding a pace to a repetitive primary task to increase the speed of processing;
(b) adding a distraction to a repetitive primary task;
(c) adding a mental activity to a repetitive primary task; and
(d) adding combinations thereof.

3. The method of claim 2, wherein the step (c) addition of a mental activity further comprises:
adding a second repetitive task.

4. The method of claim 1, wherein the step (b) of adding a conscious stimuli to a repetitive primary task further comprises an additional complexity of presentation selected from the group consisting of: intermittent presentation, separate presentation of one conscious stimuli, combination presentation of a plurality of conscious stimuli, and combinations thereof.

5. The method of claim 1 further comprising:
e) increasing the length of the duration of the repetitive primary task.

6. The method of claim 2, wherein adding a pace further comprises:
increasing the task pace with task achievement up to a maximum task pace.

7. The method of claim 2 wherein adding a distraction further comprises one member selected from the group consisting of: increasing distraction sensory intensity from quiet to loud, increasing distraction significance from meaningless to meaningful, increasing the distraction from random to consistent and combinations thereof.

8. The method of claim 2 wherein the added mental activity increases over time from requiring minimal consciousness to demanding substantial cognitive attention.

9. A method as in claim 8 wherein the added mental task comprises a cognitive task requiring more consciousness than the primary task requires.

10. The method of claim 8 wherein the added mental task comprises a cognitive task requiring almost total consciousness.

11. The method of claim 1 further comprising:
f) providing feedback to the trainee when responses fail to be accurate and timely.

12. The method of claim 11 wherein the step of providing student feedback further comprises:
one member selected from the group consisting of: providing immediate correction, providing delayed correction thereby giving the student a chance to self correct, providing correction after the task is completed and combinations thereof.

13. The method of claim 12 further comprising the step of providing feedback to the student after a plurality of responses fail to be made as required, the feedback provided by means of one member selected from the group consisting of visual stimuli, auditory stimuli, kinesthetic stimuli, and combinations thereof.

14. The method of claim 1 further comprising the step of:
g) reporting performance to the student at the end of a time duration,
h) comparing performance to a pre-assigned passing performance level, and wherein
i) a passing performance level results in advancement to an increased level of difficulty while a non-passing performance level of performance results in repetition of the primary task.

15. The method of claim 6 further comprising:
j) providing a repetitive and patterned time interval to indicate to the trainee the required pace of responses.

16. The method of claim 15, wherein the required pace is provided by means of one member selected from the group consisting of visual stimuli, auditory stimuli, kinesthetic stimuli, and combinations thereof.

17. The method of claim 1, wherein the cognitive skills to be trained by the trainee includes at least one member selected from the group consisting of: attention, processing speed, short term memory, visual processing, auditory processing, long term memory, logic/reasoning, and cognitive sub-skills thereof.

18. The method of claim 1 wherein the repetitive primary task and the conscious stimuli are provided by a digital device with a visual display.

19. The method of claim 18 further comprising the step of having the digital device with a visual display monitor timing and accuracy of responses and implement progress based on the speed and accuracy of the responses.

20. The method of claim 18 wherein the digital device with a visual display is programmed to further carry out one member selected from the group consisting of: increase intensity of conscious stimuli based on the speed of the responses, increase complexity of conscious stimuli based on the speed of the responses, increase pace of the repetitive primary task based upon speed of the responses, provide feedback based upon speed of the responses, increase intensity of conscious stimuli based on the accuracy of the responses, increase complexity of conscious stimuli based on the accuracy of the responses, increase pace of the repetitive primary task based upon accuracy of the responses, provide feedback based upon accuracy of the responses, and combinations thereof.
